(19) United States
(12) Patent Application Publication
(10) Pub. No.: US 2025/0346024 A1
(43) Pub. Date: Nov. 13, 2025

(54) COMPOSITE POLYUREA STRUCTURE AND METHOD OF FABRICATING SAME

(71) Applicant: American Polymers Corporation, Santa Fe Springs, CA (US)

(72) Inventors: Dustin Le, Santa Fe Springs, CA (US); Ashish Dhuldhoya, Santa Fe Springs, CA (US); Hemant J. Prajapati, Santa Fe Springs, CA (US)

(21) Appl. No.: 19/197,856

(22) Filed: May 2, 2025

Related U.S. Application Data
(60) Provisional application No. 63/643,647, filed on May 7, 2024.

(51) Int. Cl. B32B 27/06; B32B 27/40; B32B 38/00

(52) U.S. Cl. CPC B32B 27/065; B32B 27/40; B32B 38/0036; B32B 2038/0076; B32B 2250/03; B32B 2250/40; B32B 2307/536; B32B 2307/72; B32B 2307/7376

(57) ABSTRACT

Methods for producing molded composite products are disclosed whereby a polyurethane elastomer layer can be applied to a mold, followed by the application of a elastomer foam layer upon that polyurethane layer. If desired, a second polyurethane elastomer layer can be applied upon the exposed elastomer foam layer. After application and curing of all layers, the composite structure may be removed from the mold. The resulting structure may have a seamless bond between the elastomer foam layer and any polyurethane elastomer layers, which could be strong enough to remain inseparable by forces like impact, shear, and pull off adhesion.

### CROSS-REFERENCE TO RELATED APPLICATIONS

This application relates to and claims the benefit of U.S. Provisional Application No. 63/643,647 filed May 7, 2024, and entitled “COMPOSITE POLYUREA STRUCTURE AND METHOD OF FABRICATING SAME,” the entire disclosure of which is hereby wholly incorporated by reference.

### STATEMENT RE: FEDERALLY SPONSORED RESEARCH/DEVELOPMENT

Not Applicable

### BACKGROUND

### 1. Field of Invention

The present application relates to polyurethane composite structures. More specifically, the present application relates to polyurethane composite structures having a strong, seamless bond between a solid polyurethane elastomer and an elastomer foam.

### 2. Related Art

Polyurea composite structures can be manufactured by applying one or more polyurea/polyurethane coatings upon a mold, usually via reverse molding. This is traditionally performed by applying (with, for example, a plural component spray gun) at least two compositions, including an isocyanate component and a resin component, on the outer surface of a mold. These components may be allowed to react upon a mold until they have cured to reach a level of hardness which would permit another polyurea/polyurethane coating to be applied. The order of application and the specific compounds of these coatings may determine the mechanical properties of the final composite structure formed upon the mold. By allowing all of the applied coatings to cure, the composite structure may be formed and subsequently removed from the mold and used as, for instance, a bathtub, a sink, a part of a boat, etc. Examples of such coatings which may be applied to a mold are disclosed in U.S. Pat. No. 6,841,111, entitled “Method for making a polyurea composite structure substantially free of volatile organic compounds,” U.S. Pat. No. 7,001,948 entitled “Polyurea coating compositions”, and Applicant's previously filed U.S. patent application Ser. No. 18/514,861 entitled “Sprayed Multilayer Polyurea and Polyurethane Composites,” the entire disclosures of each of which are wholly incorporated herein by reference. However, the bond between the different coatings of prior art polyurea-polyurethane composite structures can be weak and prone to breaking in response to force impact, shear, pull of adhesion, etc. As such, there is a need in the art for improved polyurea composite structures having stronger bonds between individual layers.

### BRIEF SUMMARY

To solve these and other problems, composite structures and methods of manufacturing such structures are disclosed. A method of producing a molded composite structure may comprise the steps of applying a polyurethane elastomer layer to a mold by spraying a first set of components with a first spray system, applying an elastomer foam layer to the polyurethane layer by spraying a second set of components with a second spray system, allowing the polyurethane elastomer layer and the elastomer foam layer to cure to form the molded composite structure, and removing the molded composite structure from the mold. The first spray system may comprise an air purge spray gun, and the temperature of the first set of components can each individually range from 70 degrees Fahrenheit to 200 degrees Fahrenheit, preferably 80 degrees Fahrenheit to 190 degrees Fahrenheit, and most preferably 90 degrees Fahrenheit to 180 degrees Fahrenheit, when being sprayed. The first set of components can each individually be sprayed at a spray pressure ranging from 1,000 psi to 3,000 psi, preferably from 2,000 psi to 2,900 psi, and most preferably from 2,500 psi to 2,800 psi. The second spray system may comprise an air purge spray gun, and the temperature of the second set of components can each individually range from 70 degrees Fahrenheit to 200 degrees Fahrenheit, preferably 80 degrees Fahrenheit to 190 degrees Fahrenheit, and most preferably 90 degrees Fahrenheit to 180 degrees Fahrenheit, when being sprayed. The second set of components can each individually be sprayed at a spray pressure ranging from 1,000 psi to 3,000 psi, preferably from 1,500 psi to 2,500 psi, and most preferably from 1,800 psi to 2,200 psi. The resulting molded composite structure may comprise a seamless bond between the polyurethane elastomer layer and the elastomer foam layer. The composite structure could come in the form of a sink, a bathtub, a part of a boat, a part of an automobile, a part of a building, or a part of a manufacturing facility.

The polyurethane elastomer layer may have a thickness ranging from 10 mils to 3 inches. The elastomer foam layer can have a thickness ranging from 10 mils to 40 inches. The molded composite structure can have a material density ranging from 0.3 pounds/cubic foot to 80 pounds/cubic foot and a material hardness ranging from 5 shore A to 85 shore D.

The method could further comprise a step of applying a second polyurethane elastomer layer to the elastomer foam layer; this could be done before removing the structure from the mold. The second polyurethane elastomer layer can be applied by spraying a third set of components with the first spray system (the same spray system used to apply the first polyurethane elastomer layer) or a separate third spray system comprising an air purge spray gun. The third set of components could be the same as the first set of components or they may differ if it is desirous to have polyurethane layers with differing properties on each side of the composite. The temperature of the third set of components may each individually range from 70 degrees Fahrenheit to 200 degrees Fahrenheit, preferably 80 degrees Fahrenheit to 190 degrees Fahrenheit, and most preferably 90 degrees Fahrenheit to 180 degrees Fahrenheit, when being sprayed and each of the third set of components may individually be sprayed at a spray pressure ranging from 1,000 psi to 3,000 psi, preferably from 2,000 psi to 2,900 psi, and most preferably from 2,500 psi to 2,800 psi.

The reaction between any polyurethane elastomer layers and the elastomer foam layer may comprise reactions between polyisocyanates, amines, polyols, and curing agents. Any polyisocyanates could have an isocyanate (NCO) content ranging from 1% to 35%. The average molecular weight of the amines present may range from 50-50,000 g/mol. The polyols can comprise diols, triols, 4 functional polyols, 5 functional polyols, or combinations thereof.

All of these embodiments are contemplated to be within the scope of this disclosure. These and other embodiments will become readily apparent to those skilled in the art from the following detailed description of the preferred embodiments having reference to the attached figures, the disclosure not being limited to any particular preferred embodiment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIGS. 1-3 are various views of a cross-sectional piece of a first working composite structure having a polyurethane elastomer layer and an elastomer layer, showcasing a seamless bond between the two; and

FIG. 4 is a view of a cross-sectional piece of a second working embodiment having polyurethane elastomer layers on either side of an elastomer foam layer.

### DETAILED DESCRIPTION

Disclosed herein are composite polyurea structures and methods of fabricating the same which comprise a seamless bond between a solid polyurethane elastomer and an elastomer foam. This bond may be strong enough to remain inseparable when the structure experiences various types of forces, such as force impact, shear, pull off adhesion, etc. Plural components spray systems may be used to apply at least two components, usually designated as an A-side isocyanate component and a B-side resin component, upon a mold to apply a layer to a mold. These components, which can include isocyanate and resin components, may react upon the surface of the mold and be allowed to cure to form corresponding layer, such as a polyurethane elastomer layer. An additional layer, such as an elastomer foam layer, can be applied with a plural component spray system and that layer's precursor components. When all applied layers have cured, the molded composite structure may be formed and thereafter removed from the mold. Such molded composites may then be used in a variety of commercial, residential, and/or industrial applications, including, but not limited to, sinks, bathtubs, boats, automobiles, buildings, structures in factories or other manufacturing facilities, and more. By specifying certain parameters on the plural component spray systems, including setting temperature ranges of the components from 70 degrees Fahrenheit to 200 degrees Fahrenheit and spray pressure ranges from 1,000 psi to 3,000 psi, the resulting composite structure may have a seamless bond between the polyurethane elastomer layer and the structural foam layer which can be resistant to a wide range of forces the composite structure could be exposed to.

This description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

A polyurethane elastomer can be applied with a high pressure, high heat plural component machine, such as a plural component spray system comprising an air purge spray gun, onto a mold. In particular, this polyurethane elastomer can be applied upon the mold by spraying its corresponding components while the temperature of the components ranges from 70 degrees Fahrenheit to 200 degrees Fahrenheit, preferably 80 degrees Fahrenheit to 190 degrees Fahrenheit, and most preferably 90 degrees Fahrenheit to 180 degrees Fahrenheit, and with a spray pressure ranging from 1,000 psi to 3,000 psi, preferably from 2,000 psi to 2,900 psi, and most preferably from 2,500 psi to 2,800 psi. Reservoirs holding these components, the hoses connecting these reservoirs to a spray gun, or both can be heated to this 70 degrees Fahrenheit to 200 degrees Fahrenheit temperature range in order to heat the components accordingly. A polyurethane elastomer layer can be applied upon a mold at a thickness ranging from 10 mils to 3 inches. When this layer is cured, it may have a material harness ranging from 5 shore A to 85 shore D, tensile pressure ranging from 100 psi to 12,000 psi, a percent elongation ranging from 0.01% to 800%, and/or a flexural modulus ranging from 500 psi to 800,000 psi. This polyurethane elastomer layer can be given tack-free time from 1 second to 72 hours, after which the next layer can be applied.

An elastomer foam layer may be applied to the polyurethane elastomer layer with a high pressure, high heat plural component machine, such as a plural component spray system comprising an air purge spray gun. The components corresponding to this layer can be applied while the temperature of the components ranges from 70 degrees Fahrenheit to 200 degrees Fahrenheit, preferably 80 degrees Fahrenheit to 190 degrees Fahrenheit, and most preferably 90 degrees Fahrenheit to 180 degrees Fahrenheit, and with a spray pressure ranging from 1,000 psi to 3,000 psi, preferably from 1,500 psi to 2,500 psi, and most preferably from 1,800 psi to 2,200 psi. Reservoirs holding these components, the hose connecting these reservoirs to a spray gun, or both can be heated to these temperatures. This elastomer foam layer can be applied at a thickness ranging from 10 mils to 40 inches.

If desired, a second polyurethane elastomer layer can then be applied upon the elastomer foam layer. This second polyurethane elastomer layer may be substantially similar to the first polyurethane elastomer layer, in that it can have similar physical properties, be applied at the same thickness, temperature, and/or spray pressure ranges, and/or have precursor components with similar properties to one another; in this case, the same spray system used for the first polyurethane layer and the same components could be used for the application of this second polyurethane layer. Alternatively, a different spray system and different components may be used for this second polyurethane elastomer layer, as may be the case when one desires a composite structure having two outer polyurethane elastomer layers with differing properties. A composite structure formed from these embodiments may, by virtue of elastomer layers forming tenacious bonds on either side of an elastomer foam layer, have an I-Beam structure.

The composite structure formed in either embodiment may be the result of reactions between the components, specifically reactions of polyisocyanates, amines, polyols, and curing agents present in any of the applied layers. In particular, the polyisocyanates can have an isocyanate (NCO) content ranging from 1% to 35% and/or the average molecular weight of the amines can range from 50-5,000 g/mol. The polyols may comprise diols, triols, 4 functional polyols, 5 functional polyols, or combinations thereof. The reaction mixture of the polyurethane elastomer layer and elastomer foam layers may have one or more of: a cream time ranging from 1 second to 1 hour, a gelation time ranging from 1 second to 1 hour, a tack free time ranging from 1second to 24 hours. The material density of the cured composite structure can have a material density ranging from 0.3 pounds/cubic foot to 80 pounds/cubic foot, and the material hardness of this composite structure can range from 5 shore A to 85 shore D.

The final composite structure can be used in a variety of applications, such as a sink, a bathtub, part of a boat, part of an automobile, part of a building, part of a manufacturing facility, and more.

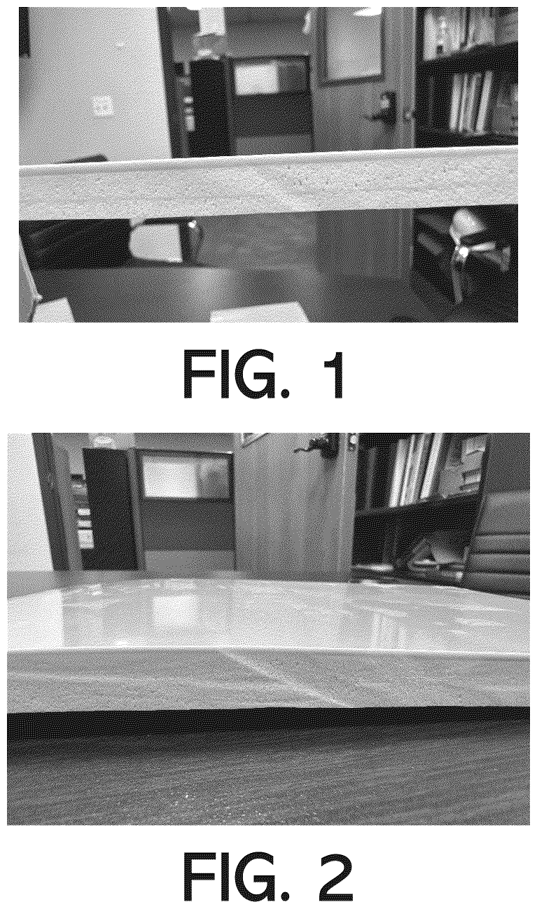

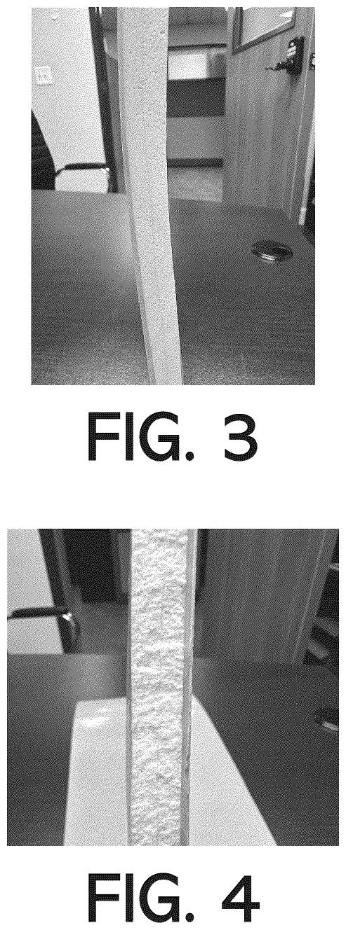

Turning now to FIGS. 1-3 and 4, two working embodiments of composite structures produced according to the present disclosure are shown, with FIGS. 1-3 showing various views of a cross-sectional piece of a first working composite structure having a polyurethane elastomer layer and an elastomer layer and FIG. 4 showing a cross-sectional piece of a second working embodiment having polyurethane elastomer layers on either side of an elastomer foam layer. A seamless bond can be seen between the solid polyurethane elastomer layers and the elastomer foam in each embodiment. This bond has been found to be strong, remaining inseparable when the composite structure is exposed to forces like force impact, shear, and pull off adhesion.

The following tables detail specifications of the plural component spray systems from Graco® which were used for the application of the polyurethane elastomer layers and the elastomer foam layers in each of the working embodiments shown in FIGS. 1-4. Table 1 describes the system and parameters associated with the application of the polyurethane elastomer layers, while Table 2 describes the same for the application of the elastomer foam layers. When relevant, “A” ISO refers to an isocyanate A-side component and “B” RES refers to a resin B-side component.

TABLE 1

| | |
|---|---|
| Proportioner | Graco Reactor 3 EXP-2 |
| Spray Gun | Graco Fusion AP |
| Spray Gun Type | Air Purge |
| Mix Chamber Part Number | Graco #AF4242 |
| Impingement Port/Orifice | 0.042 (Drill #58) (Graco #246629) |
| “A” ISO & “B” RES | |
| Nozzle Orifice Size | 0.094 (Drill 3/32) (Graco #264624) |
| Spray Flat Tip | (Graco #FT0638), width 12-14 in., orifice |
| | diameter 0.038 medium flow |
| Spray Flat Tip Gasket | (Graco #246360) |
| Gun Filter Size on “A” | 40 mesh (Graco #246357) |
| ISO & “B” RES | |
| Temperature | “A” ISO material temperature in drum: 100 |
| | degrees Fahrenheit |
| | “B” RES material temperature in drum: 100 |
| | degrees Fahrenheit |
| | “A” ISO material pressure at Y-strainer: 100 |
| | degrees Fahrenheit min |
| | “B” RES material temperature at Y-strainer: |
| | 100 degrees Fahrenheit min |
| | “A” side SIO material heater temperature set |
| | point: 139 degrees Fahrenheit |
| | “B” side RES material heater temperature set |
| | point: 166 degrees Fahrenheit |
| | Heater hose temperature set point: 139 |
| | degrees Fahrenheit Part-A ISO and 166 |
| | degrees Fahrenheit Part-B Res |
| Pressures | “A” ISO Material Transfer Pump Fluid |
| | Pressure At Displacement Pump Inlet: min of |
| | 60 psi |
| | “B” RES Material Transfer Pump Fluid |
| | Pressure At Displacement Pump Inlet: min of |
| | 60 psi |
| | “A” ISO material spray pressure set point: |
| | 2600 psi |
| | “B” RES material spray pressure set point: |
| | 2600 psi |

TABLE 2

| | |
|---|---|
| Proportioner | Graco Reactor 3 E-30 |
| Spray Gun | Graco Fusion AP |
| Spray Gun Type | Air Purge |
| Mix Chamber Part Number | Graco #AF4242 |
| Impingement Port/Orifice | 0.042 (Drill #58) (Graco #246629) |
| “A” ISO & “B” RES | |
| Nozzle Orifice Size | 0.094 (Drill 3/32) (Graco #264624) |
| Stud Wall Foam Kit | (Graco #249421) |
| Stud Wall Tip | (Graco #FTM762), width 14 in., orifice |
| | diameter 0.062 |
| Spray Flat Tip PACKING | (Graco #15F854) |
| Gun Filter Size on “A” | 40 mesh (Graco #246357) |
| ISO & “B” RES | |
| Temperature | “A” ISO material temperature in drum: 100 |
| | degrees Fahrenheit |
| | “B” RES material temperature in drum: 100 |
| | degrees Fahrenheit |
| | “A” ISO material pressure at Y-strainer: 100 |
| | degrees Fahrenheit min |
| | “B” RES material temperature at Y-strainer: |
| | 100 degrees Fahrenheit min |
| | “A” side SIO material heater temperature set |
| | point: 150 degrees Fahrenheit |
| | “B” side RES material heater temperature set |
| | point: 160 degrees Fahrenheit |
| | Heater hose temperature set point: 150 |
| | degrees Fahrenheit Part-A ISO and 160 |
| | degrees Fahrenheit Part-B Res |
| Pressures | “A” ISO Material Transfer Pump Fluid |
| | Pressure At Displacement Pump Inlet: min of |
| | 60 psi |
| | “B” RES Material Transfer Pump Fluid |
| | Pressure At Displacement Pump Inlet: min of |
| | 60 psi |
| | “A” ISO material spray pressure set point: |
| | 2000 psi |
| | “B” RES material spray pressure set point: |
| | 2000 psi |

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A method of producing a molded composite structure, the method comprising the steps of:
applying a polyurethane elastomer layer to a mold by spraying a first set of components with a first spray system, the first spray system comprising an air purge spray gun, a temperature of the first set of components each individually ranging from 70 degrees Fahrenheit to 200 degrees Fahrenheit when being sprayed, the first set of components each individually being sprayed at a spray pressure ranging from 1,000 psi to 3,000 psi;
applying an elastomer foam layer to the polyurethane layer by spraying a second set of components with a second spray system, the second spray system comprising an air purge spray gun, a temperature of the second set of components each individually ranging from 70 degrees Fahrenheit to 200 degrees Fahrenheit when being sprayed, the second set of components each individually being sprayed at a spray pressure ranging from 1,000 psi to 3,000 psi;
allowing the polyurethane elastomer layer and the elastomer foam layer to cure to form the molded composite structure; and
removing the molded composite structure from the mold;
wherein the molded composite structure comprises a seamless bond between the polyurethane elastomer layer and the elastomer foam layer.

2. The method of claim 1, wherein the polyurethane elastomer layer has a thickness ranging from 10 mils to 3 inches.

3. The method of claim 1, wherein the elastomer foam layer has a thickness ranging from 10 mils to 40 inches.

4. The method of claim 1, wherein the molded composite structure has a material density ranging from 0.3 pounds/cubic foot to 80 pounds/cubic foot.

5. The method of claim 1, wherein the molded composite structure has a material hardness ranging from 5 shore A to 85 shore D.

6. The method of claim 1, wherein the method further comprises a step of:
applying a second polyurethane elastomer layer to the elastomer foam layer.

7. The method of claim 6, wherein the second polyurethane elastomer layer is applied by spraying a third set of components with the first spray system or a third spray system comprising an air purge spray gun.

8. The method of claim 7, wherein the third set of components are the same as the first set of components.

9. The method of claim 7, wherein a temperature of the third set of components each individually range from 70 degrees Fahrenheit to 200 degrees Fahrenheit when being sprayed; and
wherein the third set of components are each individually sprayed at a spray pressure ranging from 1,000 psi to 3,000 psi.

10. The method of claim 1, wherein said step of allowing the polyurethane elastomer layer and the elastomer foam layer to cure to form the molded composite structure comprises reactions between polyisocyanates, amines, polyols, and curing agents.

11. The method of claim 10, wherein the polyisocyanates have an isocyanate (NCO) content ranging from 1% to 35%.

12. The method of claim 10, wherein the average molecular weight of the amines ranges from 50-50,000 g/mol.

13. The method of claim 10, wherein the polyols comprise diols, triols, 4 functional polyols, 5 functional polyols, or combinations thereof.

14. The method of claim 1, wherein the composite structure is a sink, a bathtub, a part of a boat, a part of an automobile, a part of a building, or a part of a manufacturing facility.

15. The molded composite structure produced by the method of claim 1.
